(19) United States
(12) Patent Application Publication
(10) Pub. No.: US 2010/0057442 A1
(43) Pub. Date: Mar. 4, 2010

(54) DEVICE, METHOD, AND PROGRAM FOR DETERMINING RELATIVE POSITION OF WORD IN LEXICAL SPACE

(76) Inventor: Hiromi Oda, Tokyo (JP)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/513,158

(22) PCT Filed: Oct. 31, 2007
(86) PCT No.: PCT/JP2007/071186

§ 371 Date: Apr. 30, 2009

(30) Foreign Application Priority Data
Oct. 31, 2006 (JP) 2006-296803

(51) Int. Cl. G06F 17/27

(52) U.S. Cl. 704/9; 704/E15.025

(57) ABSTRACT

The position of a word in the lexical space is determined stably and highly accurately by arbitrarily setting a predetermined initial condition, determining the occurrence frequency and cooccurrence relationship of the word under a given condition, and minimizing the difference between the values of the occurrence frequency and cooccurrence and the initial layout values arbitrarily set.

### TECHNICAL FIELD

The present invention relates to determination of a relative location of lexical items mutually related to each other in an arbitrary field in a lexical space.

### BACKGROUND ART

Measuring the relationships between lexical items mutually related to each other in a specific field, to thereby construct a lexical space which reflects the measured results have been considered.

Visualizing a lexical space by arranging lexical items in a two- or three-dimensional space especially based on human perception for facilitating the understanding of semantic relationships is useful. Visualization also facilitates the recognition of the relationships between a vocabulary of interest and lexical items therearound.

Various application examples thereof have been proposed, such as application to an analysis of lexical features in a subject field, including an analysis of features of lexical items used in an online community, and to an interface, which is used for requesting for the selection of an appropriate vocabulary item for phenomena, which are generally hard to be described, such as favorites of a user and symptoms of a disease. Conventionally, the lexical space has been constructed by applying a multi-dimensional scaling technique, but the present invention discloses a device, a program, and a method involving calculation of a stable lexical space for semantically close lexical neighborhood under certain conditions.

Patent Document 1: JP 2005-309853 A (Method, system or memory storing a computer program for document processing).

Non Patent Document 1: Takane, Y. 2005. Applications of multidimensional scaling in psychometrics. In C. R. Rao and S. Sinharay (Eds.), Handbook of Statistics (Vol. 27): Pyschometrics. Amsterdam: Elsevier.

Non Patent Document 2: Honkela, T. 1997. Self-Organizing Maps in Natural Language Processing, Ph.D. thesis, Helsinki University of Technology.

Non Patent Document 3: T. Kohonen, 1995. Self-Organizing Maps, Springer.

Non Patent Document 4: Holger Theisel and Matthias Kreuseler, 1999, An Enhanced Spring Model for Information Visualization, EUROGRAPHICS '98, Vol. 1, No. 3.

Non Patent Document 5: W. K. Church and P. Hanks, 1990. Word association norms, mutual information, and lexicography, Computational Linguistics, Vol. 16, No. 1, 22-29.

### DISCLOSURE OF THE INVENTION

### Problems to be Solved by the Invention

Conventionally, when arranging a large number of lexical items in a multi-dimensional space, the most commonly used method is referred to as the multi-dimensional scaling (MDS) technique, and various models have been proposed. However, this method is originally used to construct an unknown multi-dimensional space from measured values obtained by measurements in the field of experimental psychology, and is not necessarily appropriate for the construction of a lexical space.

For the construction of the lexical space, there are many cases where certain assumptions/hypotheses for structures of the lexical space have already been found by linguistic research, and there is a need for constructing the lexical space according to the assumptions. According to the multi-dimensional scaling technique, a mathematical technique, which is generally referred to as singular value decomposition, is used. However, a method, such as the singular value decomposition, which employs a principle of finding axes best describing variations in data, does not consider a case in which assumptions/hypotheses are specified in advance, and a lexical space is determined accordingly, and, it seems that the method employing the singular value decomposition does not permit the specifications described above.

As methods for calculating a network or a graph based on observed distances, methods such as a self-organizing map and a physical model, such as a spring model and the like, have additionally been proposed.

It does seem possible to specify the assumptions/hypotheses in advance by those methods, but none of those methods are intended for a lexical space. In addition, an effective method for constructing a lexical space has not yet been proposed. Further, even when a pair of lexical items in question are both high frequency words, which are generally frequently used, they may not occur together in a subject document data. In this case, according to conventional methods, distances between all pairs of words which do not occur together are not defined, but there are a large number of word pairs for which the possible maximum distance calculated as a distance between lexical items is specified, resulting in instability in the lexical space.

The present invention proposes a method, in order to solve the above-mentioned problems, for achieving stability of a constellation at a precision level that cannot be obtained by conventional methods, while permitting the setting of assumptions in the lexical space under the following conditions.

(a) A lexical space is limited to a lexical neighborhood.

(b) Lexical items are directly arranged in a two-dimensional space.

(c) A small number of words are arranged in advance based on assumptions on the lexical space.

Moreover, when a pair of lexical items in question are both high frequency words in general documents, but do not occur together in the subject document data, it can be considered that a repelling force that increases the distance between the pair of lexical items exists in the lexical space of the subject document. Based on this reasoning, a method of defining a predetermined distance for such lexical items with the co-occurrence frequency of zero is disclosed.

### Means for Solving the Problems

[Claim 1]

Claim 1 discloses a device for determining a relative location in a two-dimensional space of words mutually related in an arbitrary field, including:

(a) a unit for receiving n documents B(i) relating to the arbitrary field, m lexical neighborhood lexical items W(i) of lexical items used in the arbitrary field, k specified lexical items A(i), and location information P on the k specified lexical items A(i) in the two-dimensional space;

(b) a unit for determining an n by m frequency matrix V(i,j) using the n documents B(i) relating to the arbitrary field, and the m lexical neighborhood lexical items W(i);

(c) a unit for calculating an m by m observed distance matrix M(i,j) using the n by m frequency matrix V(i,j);

(d) a unit for determining an m by m lexical location matrix D(i,j) from the location information P in the two-dimensional space on the specified lexical items and initial locations determined arbitrarily in the two-dimensional space of lexical items other than the specified lexical items; and

(e) a unit for determining a stress function S based on the m by m lexical location matrix D(i,j) and the m by m observed distance matrix M(i,j), and determining an m by m lexical location matrix D(i,j) minimizing the stress function S.

[Claim 2]

Further, claim 2 discloses, in a device of claim 1, the unit for calculating the m by m observed distance matrix M(i,j) further includes:

(a) a unit for determining an m by m co-occurrence matrix C(i,j) according to (Equation 1):

C(i,j)=V^{T}V (Equation 1)

where T denotes a trans location of a matrix; and

(b) a unit for determining the m by m observed distance matrix M(i,j) from the m by m co-occurrence matrix C(i,j) according to (Equation 2):

M(i,j)=−2×C(i,j)/{tf(i)×tf(j)} for C(i,j)≠0

{tf(i)×tf(j)}/(2×β) for C(i,j)=0 (Equation 2)

where C(i,j) is a value of the co-occurrence matrix of each vocabulary pair, tf(j) is a frequency of a vocabulary in entire documents, and β is a maximum value of tf(i) (i=1 to m).

[Claim 3]

Claim 3 discloses, in the device of claim 1, at least three specified lexical items, and locations of the specified lexical items in the two-dimensional space are input to the means for receiving the specified lexical items, and the locations of the specified lexical items in the two-dimensional space.

[Claim 4]

Claim 4 discloses the device according to claim 1, further including:

(a) a unit for receiving a specification of a naïve vocabulary;

(b) a unit for selecting row data corresponding to the naïve vocabulary from a lexical mapping matrix;

(c) a unit for selecting an expert vocabulary corresponding to the selected row data, and a column data corresponding to the expert vocabulary; and

(d) a unit for determining a naïve vocabulary corresponding the selected column data, and determining the lexical neighborhood vocabulary W(i).

[Claim 5]

Claim 5 discloses a computer readable storage medium having stored thereon a computer program for controlling a computer to operate the device of claim 1.

[Claim 6]

Claim 6 discloses a method to be used in the device of claim 1.

[Claim 7]

Claim 7 discloses a method to be used in the device of claim 2.

[Claim 8]

Claim 8 discloses a method to be used in the device of claim 3.

[Claim 9]

Claim 9 discloses a method to be used in the device of claim 4.

### EFFECTS OF THE INVENTION

The present invention may determine a constellation of lexical items at a high level of precision that cannot be obtained by conventional technologies. The present invention is also able to determine the constellation of lexical items in a stable manner. Consequently, mutual relationships between lexical items in a predetermined specific field in a lexical space may be clarified and visualized.

### BRIEF DESCRIPTION OF THE DRAWINGS

FIG. 1 is a diagram illustrating a device embodying the present invention.

FIG. 2 is a block diagram illustrating a preferred embodiment of the present invention.

FIG. 3 is a flowchart illustrating the preferred embodiment of the present invention.

FIG. 4 is a diagram illustrating a vocabulary frequency matrix according to the present invention.

FIG. 5 is a diagram illustrating an example of locations of specified lexical items in a two-dimensional space.

FIG. 6 is a diagram illustrating an example in which other lexical items are arranged at random as an initial constellation.

FIG. 7 is a diagram illustrating an example of a result after the present invention has been applied.

FIG. 8 is a diagram illustrating an example of a lexical mapping matrix.

FIG. 9 is a flowchart for determining lexical neighborhood lexical items from the lexical mapping matrix.

FIG. 10a is a diagram illustrating an example of an initial constellation according to the present invention.

FIG. 10b is a diagram illustrating an example of a result after the present invention has been applied.

FIG. 11a is a diagram illustrating an example of an initial constellation according to the present invention.

FIG. 11b is a diagram illustrating an example of a result after the present invention has been applied.

### BEST MODE FOR CARRYING OUT THE INVENTION

### Overview of Device

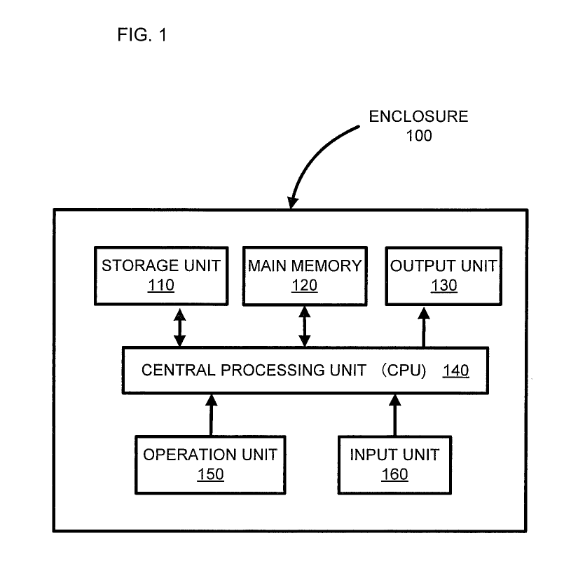

FIG. 1 illustrates a device embodying the present invention.

An enclosure 100 includes a storage unit 110, a main memory 120, an output unit 130, a central processing unit (CPU) 140, an operation unit 150, and an input unit 160. A user inputs necessary information from the operation unit 150. The central processing unit 140 reads information stored in the storage unit 110, based on the input information, carries out data processing based on information to be input from the input unit 160, and outputs results to the output unit 130. In other words, the storage unit 110 comprises a computer readable storage medium on which a program for carrying out the data processing is stored.

[Functional Block Diagram]

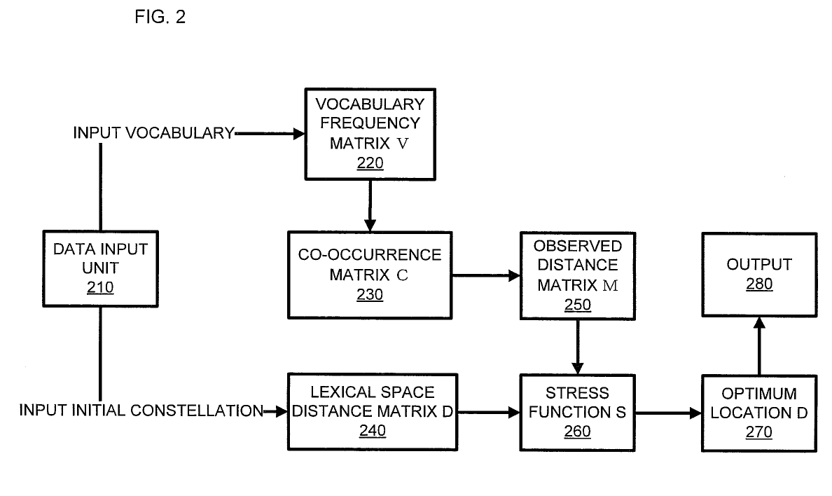

FIG. 2 illustrates a functional block diagram according to the present invention. Reference numeral 210 denotes a data input unit; 220, a unit for calculating vocabulary frequency matrix V; 230, a unit for calculating co-occurrence matrix C; 240, a unit for calculating lexical space distance function D; 250, a unit for calculating and creating observed distance matrix M; 260, a unit for calculating stress function S; 270, a unit for calculating optimum location D; and 280, an output unit.

[Algorithm]

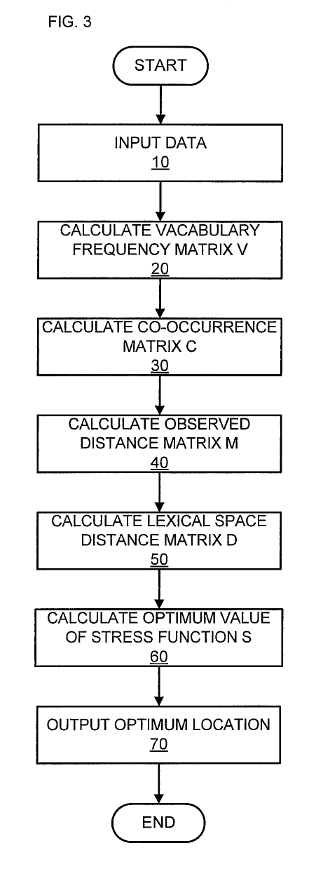

FIG. 3 illustrates a flowchart when the present invention is embodied on a computer.

10: Input data

20: Calculate vocabulary frequency matrix V

30: Calculate co-occurrence matrix C

40: Calculate observed distance matrix M

50: Calculate lexical space distance function D

60: Calculate optimum value of stress function S

70: Display optimum locations D

A detailed description is now given of this algorithm.

Construction of a lexical space disclosed by the present invention is realized by the following steps.

[Detailed Algorithm]

(1) Input Data

The following data pieces are input to carry out this embodiment 1:

(a) n documents B(i) relating to an arbitrary field (i=1 to n);

(b) m lexical neighborhood lexical items W(i) used in the arbitrary field (i=1 to m);

(c) k specified lexical items A(i) (i=1 to k); and

(d) Location information P in a two-dimensional space on the specified lexical items A(i) (i=1 to k).

A detailed description is now given of the data.

(a) n documents B(i) relating to an arbitrary field (i=1 to n).

The object of the present invention is to determine relative locations of lexical items that are mutually related to each other in a two-dimensional space for an arbitrary lexical domain, and one or more documents on a lexical domain are provided as input.

(b) m lexical neighborhood lexical items W(i) used in the arbitrary field (i=1 to m).

Lexical items that are in the subject field, and whose constellation in the two-dimensional space is to be determined are input.

For the set of lexical neighborhood lexical items W, arbitrary lexical items used in an arbitrary field may be selected. However, lexical items obtained by subjecting a large number of documents to data processing may also be used.

When a lexical neighborhood is simply considered as a set of lexical items having high degrees of relevance based on occurring data, several methods for calculating a lexical neighborhood are known. For example, a method simply employing the co-occurrence frequency, a method employing the t-score, a method employing Church & Hanks' mutual information (1990), and the like are well known. However, all of those methods are based on co-occurrence relationships between two words, and do not always identify sets of words that are semantically close to one another. In addition, those methods may collect many collocated words, such as phrases.

Therefore, when the above-mentioned method is simply used to collect words having high degrees of relevance, the collected words may not be appropriate as a “set of lexical neighborhood lexical items” defined according to the present invention.

The present invention calculates a “set of lexical neighborhood lexical items” based on data determined by a method described in JP 2005-309853 A (Method, system or memory storing a computer program for document processing), the disclosure of which is hereby incorporated by reference in its entirety.

A description is now given of how to determine a “set of lexical neighborhood lexical items”.

FIG. 8 illustrates a “lexical mapping matrix between expert descriptions and non-expert descriptions” (referred to as a lexical mapping matrix hereinafter) generated according to the lexical mapping method disclosed in JP 2005-309853 A. This lexical mapping matrix is determined by processing, according to the above-mentioned lexical mapping method, data collected by accessing Internet sites in Japan while brand names of Japanese rice wine are specified as a list of words.

In FIG. 8, in the left most column, as naïve lexical items, graceful, palatable, refreshing, sophisticated, fruity, elegant, good, mellow, melon, flavorsome, palatable, and the like are illustrated. In the upper most row, as expert lexical items, brands such as “Kotosen-nen”, “Hananomai”, and “Aizu gin-no kura” are illustrated.

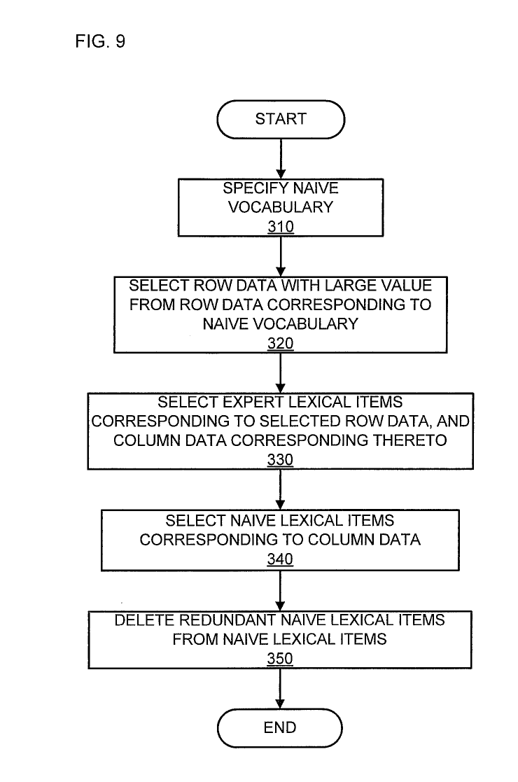

As illustrated in FIG. 9, “lexical neighborhood lexical items” are determined according to the following steps.

(1) Specify naïve vocabulary

(2) Select large row data from row data corresponding to the naïve vocabulary

(3) Select expert lexical items corresponding to the selected row data, and column data corresponding thereto

(4) Select naïve lexical items corresponding to the column data

(5) Delete redundant naïve lexical items from the naïve lexical items.

A description is now given with an illustration of a specific example.

(1) Specify a naïve vocabulary. A desired word is selected as a naïve vocabulary. In this example, “refreshing” is selected.

(2) Select large row data from row data corresponding to the naïve vocabulary. A predetermined number of data pieces with a large value are selected from the data in a row corresponding to the specified vocabulary. On this occasion, as data corresponding to “refreshing”, numerical values represented by A1, B10, and C7 are the three largest values of data in the row.

(3) Select expert lexical items corresponding to the selected row data, and column data corresponding thereto. Expert lexical items corresponding to the selected data are identified, and a predetermined number of column data pieces with a large value are selected from column data corresponding to the expert lexical items. On this occasion, “Kotosen-nen” corresponds to A1, and, from the column of “Kotosen-nen”, A1, A2, A3, A4, and the like are selected. Similarly, “Hananomai” corresponds to B10, and from the column of “Hananomai”, B1, B2, B3, B10, and the like are selected. Moreover, “Aizu gin-no kura” corresponds to C7, and from the column of “Aizu gin-no kura”, C1, C2, C3, C7, and the like are selected.

(4) Select naïve lexical items corresponding to the column data. Naïve lexical items on the rows corresponding to the predetermined number of selected column data pieces are selected. On this occasion, the lexical items, refreshing, sophisticated, palatable, and elegant, which correspond to “Kotosen-nen”, are selected. Moreover, the lexical items, aftertaste, delicious, aromatic, dry, flavorsome, and savory, which are not illustrated in FIG. 8, are selected. The lexical items, refreshing, palatable, sophisticated, and elegant, which correspond to “Hananomai”, are selected. Moreover, the lexical items, unmatured, full bodied, tasty, good, favorable, and fruity, which are not illustrated in FIG. 8, are selected. The lexical items, refreshing, graceful, mellow, and melon, which correspond to “Aizu gin-no kura” are selected. Moreover, the lexical items, lingering, lemon, smooth, fruity, light, and pleasant, which are not illustrated in FIG. 8, are selected.

(5) Delete redundant naïve lexical items from the naïve lexical items. The selected naïve lexical items, excluding redundant lexical items, are set as lexical neighborhood lexical items. According to this embodiment, as lexical items W(i) (i=1 to 25), the following lexical items are selected.

Examples of Lexical items include: refreshing, sophisticated, fruity, elegant, good, delicious, smooth, melon, lemon, mellow, graceful, light, aftertaste, full bodied, delectable, favorable, aromatic, palatable, savory, tasty, pleasant, dry, unmatured, flavorsome, and lingering.

The selected lexical items include lexical items that are different only in notation, but are considered as having substantially the same meaning, such as “smooth” and “mellow”, and thus, it is presumed that the lexical neighborhood lexical items extracted by this method constitute a group of lexical items that are close to each other in meaning.

(c) k specified lexical items A(i) (i=1 to k). At least three lexical items selected from the lexical neighborhood lexical items are input. Those lexical items are herein referred to as “specified lexical items”. By arbitrarily selecting the specified lexical items, relationships between those lexical items and other lexical items may be determined.

According to this embodiment, as the specified lexical items, the following lexical items are selected. Examples of Specified Lexical Items include: sophisticated, refreshing, and fruity.

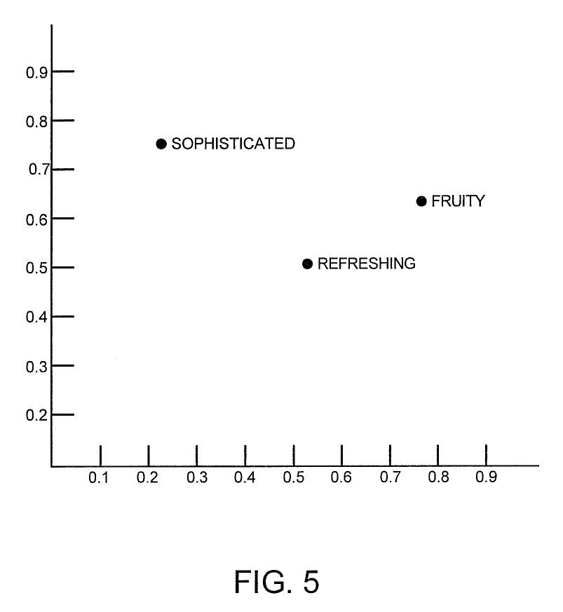

(d) Location information P in a two-dimensional space on the k specified lexical items A(i) (i=1 to k). By inputting locations of the at least three input specified lexical items in the two-dimensional space, relationships with other lexical items may be visually determined. As illustrated in FIG. 5, the specified lexical items in the two-dimensional space, “sophisticated”, “refreshing”, and “fruity” are respectively arranged at a lower left location, a lower center location, and a lower right location.

(2) Calculate vocabulary frequency matrix V (n by m). For the set of lexical neighborhood lexical items W(i) (i=1 to m), a vocabulary frequency matrix V(i,j) (i=1 to n, j=1 to m) is determined based on frequency in the n documents B(i) (i=1 to n).

Refer to block 220 of FIG. 2.

On this occasion, as the documents, documents in a related field may be arbitrarily selected. Moreover, even when the documents in the certain specific field are concerned, depending on a purpose, only documents written by experts in the fields or only documents written by naïve persons may be selected.

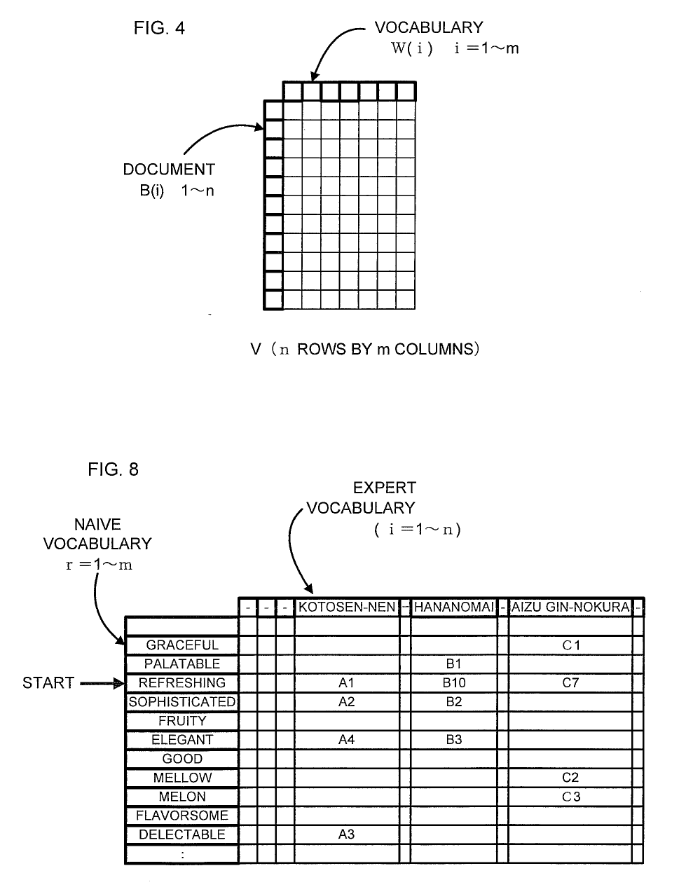

FIG. 4 illustrates an example of the n by m vocabulary frequency matrix V(i,j) (i=1 to n, j=1 to m) representing frequencies. The documents B(1) to B(n) representing arbitrary documents correspond to the vertical axis of FIG. 3. The respective lexical items W(i) (i=1 to m) of the set of lexical neighborhood lexical items W correspond to the horizontal axis. The respective elements V(i,j) of V represent a frequency of a vocabulary W(j) in a document B(i).

(3) Calculate co-occurrence matrix C (m by m). The respective elements V(i,j) of V simply represent the frequency of the respective lexical items in the respective documents. Thus, in order to consider information on co-occurrence of the respective lexical items, first, according to (Equation 1), an m by m co-occurrence matrix C(i,j) (i, j=1 to m) is calculated.

Refer to block 230 of FIG. 2.

C=V^{T}V, where T denotes a transposed matrix. (Equation 1)

(4) Calculate observed distance matrix M (m by m).

Lexical items that co-occur should naturally relate closely to each other, but a very frequent vocabulary co-occurs with a large number of other words, and it is thus necessary to consider it as less significant as a candidate for the lexical mapping. Moreover, when one document is long and thus contains a large number of lexical items, a vocabulary generated in this sentence needs to be considered as being less significant.

The case in which a pair of lexical items in question are both high frequency words that are generally frequently used and that do not co-occur in subject document data is now considered.

According to conventional technologies, when the value of the co-occurrence data is zero, whatever calculation is conducted, a relationship between the two words constituting this vocabulary pair is not defined. However, based on the fact that the lexical items, which appear frequently in general, do not co-occur, it is conceivable that those two words are in a relationship that causes them to repel each other. In other words, it is conceivable that a force for increasing the distance between the two words is acting on the two words. According to this idea, when a large number of documents are used as data to calculate distances between lexical items, even for lexical items with the co-occurrence frequency of zero, a certain distance may be defined.

This idea is very effective for arranging a large number of words in the lexical space. This is because, according to conventional methods, a distance between all pairs of words, which do not co-occur is not defined, but there are a large number of word pairs for which the possible maximum distance calculated as a distance between lexical items is defined, resulting in instability in the lexical space. By considering the repelling relationship, it is possible to reduce this unstable state. Moreover, for a vocabulary pair in the attracting relationship, when the words are high in frequency throughout the document data, and are also frequently used in other documents, compared with words that are concentrated on a document in which they co-occur, the distance should be set to be large.

Thus, based on the m by m co-occurrence matrix C(i,j) (i, j=1 to m), considering a repelling force and an attracting force between lexical items, an m by m observed distance matrix M(i,j) (i, j=1 to m) represented by (Equation 2) is created (refer to block 250 of FIG. 2).

M(i,j)=−2×C(i,j)/{tf(i)×tf(j)} for C(i,j)≠0

{tf(i)×tf(j)}/(2×β) for C(i,j)=0 (Equation 2)

where C(i,j) is a value of the co-occurrence matrix for respective vocabulary pairs, tf(j) is a frequency of the vocabulary in entire documents, and β is the maximum of tf(i) (i=1 to m). It should be noted that the value of the frequency is converted into a logarithmic form for smoothing, and when the logarithmic form is calculated for all the vocabulary pairs, values of the respective elements of the matrix M are normalized so that the minimum distance, namely the distance to itself is zero and the maximum value is one.

(5) Calculate lexical space distance function D (m by m).

A lexical space distance function D (m by m) is determined according to the following steps (a) to (c) (refer to block 230 of FIG. 2).

(a) Initial constellation of specified lexical items in two-dimensional space.

Three or more specified lexical items and their constellation information in the two-dimensional space are input by the processing described in (c) and (d) of (1). As illustrated in FIG. 5, the specified lexical items in the two-dimensional space, “sophisticated”, “refreshing”, and “fruity” are respectively arranged at the upper left location, the center location, and the right center location.

(b) Determine initial constellation of the other lexical items in two-dimensional space.

The remaining lexical items are arranged at random as an initial constellation. On this occasion, the x coordinate and the y coordinate of the respective lexical items are represented by dx(i) and dy(i) (i=1 to m).

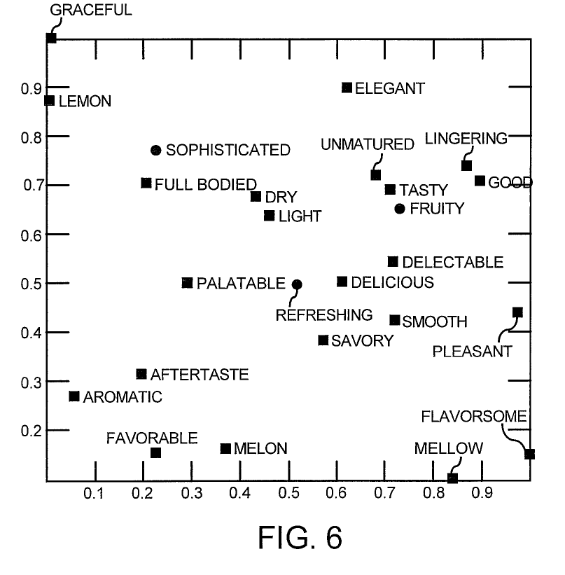

FIG. 6 illustrates an example in which the remaining lexical items are arranged at random as the initial constellation.

(c) Calculate lexical space distances D(i,j) of vocabulary pairs in two-dimensional space.

Lexical space distances D(i,j) (i, j=1 to m) of vocabulary pairs in the two-dimensional space are calculated. On this occasion, there are various possible distances in the two-dimensional space, but a Euclidean distance function represented by (Equation 3) is herein used.

D(i,j)=√{(dx(i)−dx(j))²+(dy(i)−dy(j))²} (Equation 3)

where i, j=1 to m.

(6) Calculate optimum value of stress function S.

A sum S of errors between the lexical space distances D(i,j) and the observed values M(i,j) between the vocabulary pairs in the two-dimensional space is defined as a stress by (Equation 4).

Refer to block 250 of FIG. 2.

S=ΣᵢΣⱼ((D(i,j)−M(i,j))² where i, j=1 to m (Equation 4)

By changing the locations D(i,j) of the lexical items randomly initialized, locations D(i,j) of the lexical items which minimize the stress S are determined. There are various known optimization methods, and the present invention determines the optimum value according to the trust region method, in which research has progressed recently as a method excellent in global convergence, resulting in a stable lexical space.

Refer to block 270 of FIG. 2.

(7) Output optimum locations D(i,j).

By constellating the optimum locations D(i,j) in the two-dimensional space, an optimum constellation in the two-dimensional lexical space is illustrated when the three or more lexical items and the constellation thereof are given as the initial values.

Refer to the block 280 of FIG. 2.

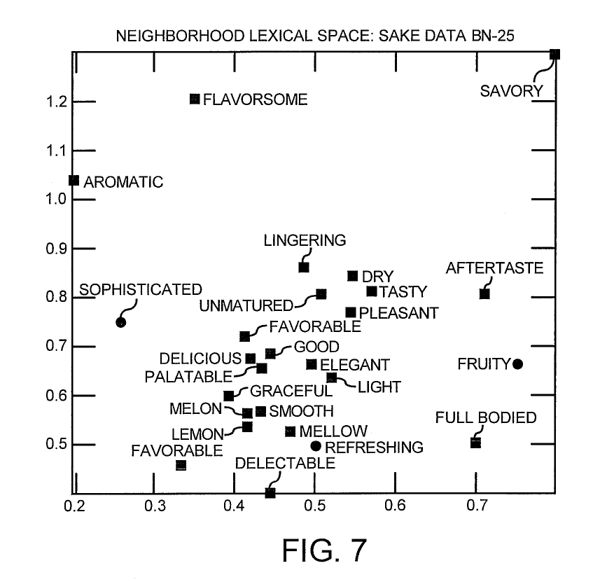

FIG. 7 illustrates a result after the application of the present invention.

[Verification of Validity of the Present Invention]

The object of the present invention is to construct a lexical space reflecting a semantic space among lexical items based on frequencies of selected lexical items, and to determine correspondences to meanings of lexical items at least at a linguistic intuitive level of a user of a language. As a result, the present invention may be effectively utilized in application fields such as analysis of relationships among lexical items and confirmation for intuitive interfaces. Thus, it is verified that a lexical space constructed based on the frequency data presents semantic correspondences according to the following method.

1. Case in which High Frequency Words do not Co-Occur

A case in which a pair of lexical items in question are both high frequency words, which are generally frequently used, do not co-occur in the subject document data, and the pair of lexical items mutually repel each other is now discussed.

For the sake of description, a case in which four lexical items t1 to t4 appear in three documents d1, d2, and d3 is now considered.

The following assumptions are made for this description.

(1) t1 and t2 co-occur in d1.
(2) t3 and t4 co-occur in d2.
(3) t3 and t1 do not co-occur in d1 to d3, and t3 and t2 do not co-occur in d1 to d3.
(4) t4 and t1 do not co-occur in d1 to d3, and t4 and t2 do not co-occur in d1 to d3.
(5) t4 is a high frequency word used frequently only in d3.

The above-mentioned relationship is represented by an n by m frequency matrix V(i,j) (i=1 to 3, j=1 to 4) as follows:

$$\begin{matrix} & & t 1 & t 2 & t 3 & t 4 & & \\ & d 1 & 10 & 10 & 00 & 00 & & \\ V = & d 2 & 00 & 00 & 10 & 10 & & \\ & d 3 & 00 & 00 & 00 & 90 & & \end{matrix} \qquad [ Expression 1 ]$$

It should be noted that tf(1)=10, tf(2)=10, tf(3)=10, and tf(4)=10+90=100.

From this frequency matrix V(i,j) (i=1 to 3, j=1 to 4), according to (Equation 1), a co-occurrence matrix C(i,j) (i, j=1 to 4) is determined, and further, according to (Equation 2), an observed distance matrix is determined as follows.

$$M = \begin{matrix} & t 1 & t 2 & t 3 & t 4 \\ t 1 & 0 & 0.0004 & 0.8456 & 1.0000 \\ t 2 & & 0 & 0.8456 & 1.0000 \\ t 3 & & & 0 & 0.2686 \\ t 4 & & & & 0\end{matrix} \qquad [ Expression 2 ]$$

On this occasion, the normalization is carried out so that the distance to itself is zero and the maximum distance is one. A result indicates that, while the distance between t1 and t2 is “0.0004”, and is thus very close, the distance “0.2686” between t4 and t3, which occur frequently, is larger than that. Moreover, for the cases in which the co-occurrence frequency is zero, the distance “1.0000” between t4 and t1 and the distance “1.0000” between t4 and t2, which occur frequently as a whole are larger than the distance “0.8456” between t3 and t1, and the distance “0.8456” between t3 and t2, and thus, the validity of the present invention is presumed.

2. Examination of Final Constellation

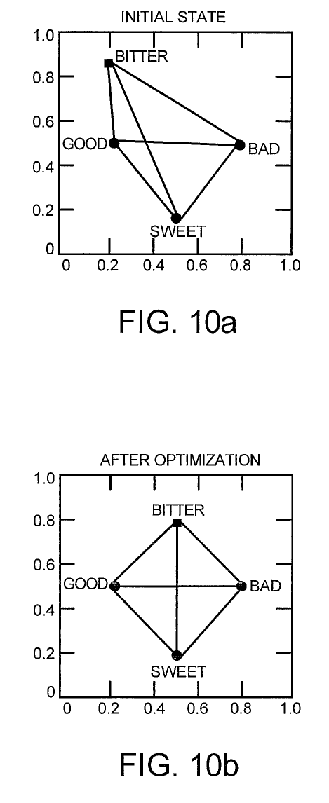

FIG. 10a illustrates an arrangement according to the present invention in which, as an initial constellation, “good” is fixed at a left center location (0.2,0.5), “sweet” is fixed at a lower center location (0.5,0.2), and “bad” is fixed at a right center location (0.8,0.5).

A case in which those three words are fixed, and, as a next word, “bitter” is to be located is to be considered.

“good” is arranged at the left center location, “bad” corresponding thereto is arranged at the right center location, and “sweet” is arranged at the lower center location. Hence, it is expected that “bitter” corresponding thereto be constellated at an upper center location in terms of meaning.

This figure (FIG. 10a) illustrates a case where a computer calculates a random number for the fourth word “bitter”, and selects an upper left location as an initial constellation. Then, when the present invention is applied while FIG. 10a is considered as an initial state, FIG. 10b is obtained as a result of the optimization based on the frequency data. On this occasion, a constellation of “bitter” is set diagonally with respect to “sweet”, and indicates that “bitter” is semantically opposite to “sweet”.

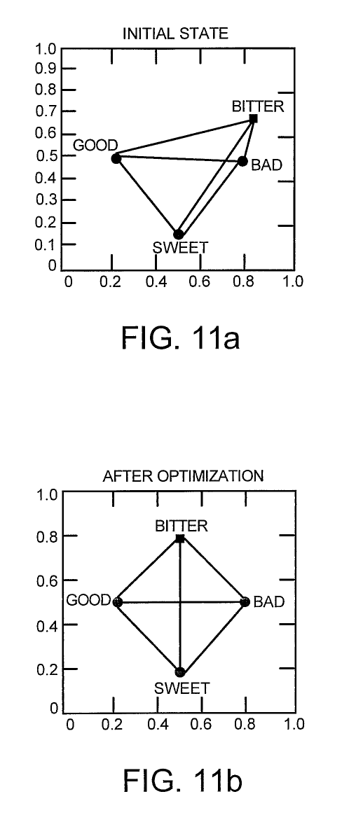

Similarly, FIG. 11a illustrates a case in which, for “bitter”, an upper right location is selected as an initial constellation. When the present invention is applied while FIG. 11a is considered as an initial state, as in FIG. 10b, FIG. 11b is obtained. This verification presents similar results for lexical items determined from document data in a plurality of different fields. As a result, validity of the present invention is presumed.

### DESCRIPTION OF THE REFERENCE NUMERALS

100: enclosure
110: storage unit
120: main memory
130: display unit
140: central processing unit (CPU)
150: operation unit
160: input unit

### INDUSTRIAL APPLICABILITY

The present invention may be applied to information processing used for the determination of the relative location of the lexical items mutually related to each other in an arbitrary field in a lexical space.

1. A device for determining a relative location in a two-dimensional space of words mutually related in an arbitrary field, comprising:
(a) a unit for receiving n documents B(i) relating to the arbitrary field, m lexical neighborhood lexical items W(i) of lexical items used in the arbitrary field, k specified lexical items A(i), and location information P on the k specified lexical items A(i) in the two-dimensional space;
(b) unit for determining an n by m frequency matrix V(i,j) using the n documents B(i) relating to the arbitrary field, and the m lexical neighborhood lexical items W(i);
(c) a unit for calculating an m by m observed distance matrix M(i,j) using the n by m frequency matrix V(i,j);
(d) a unit for determining an m by m lexical location matrix D(i,j) from the location information P in the two-dimensional space on the specified lexical items and initial locations determined arbitrarily in the two-dimensional space of lexical items other than the specified lexical items; and
(e) a unit for determining a stress function S based on the m by m lexical location matrix D(i,j) and the m by m observed distance matrix M(i,j), and determining an m by m lexical location matrix D(i,j) minimizing the stress function S.

2. A device according to claim 1, wherein the a unit for calculating the m by m observed distance matrix M(i,j) further comprises:
(a) a unit for determining an m by m co-occurrence matrix C(i,j) according to (Equation 1):
C(i,j)=V^{T}V (Equation 1)
where T denotes a transposition of a matrix; and
(b) a unit for determining the m by m observed distance matrix M(i,j) from the m by m co-occurrence matrix C(i,j) according to (Equation 2):
M(i,j)=−2×C(i,j)/{tf(i)×tf(j)} for C(i,j)≠0
{tf(i)×tf(j)}/(2×β) for C(i,j)=0 (Equation 2)
where C(i,j) is a value of the co-occurrence matrix of each vocabulary pair, tf(j) is a frequency of a vocabulary in entire documents, and β is a maximum value of tf(i) (i=1 to m).

3. A device according to claim 1, wherein the unit for receiving the specified lexical items, and the locations of the specified lexical items in the two-dimensional space receives at least three specified lexical items, and locations of the specified lexical items in the two-dimensional space.

4. A device according to claim 1, further comprising:
(a) a unit for receiving a specification of a naïve vocabulary;
(b) a unit for selecting row data corresponding to the naïve vocabulary from a lexical mapping matrix;
(c) a unit for selecting an expert vocabulary corresponding to the selected row data, and a column data corresponding to the expert vocabulary; and
(d) a unit for determining a naïve vocabulary corresponding the selected column data, and determining the lexical neighborhood vocabulary W(i).

5. A computer readable storage medium on which is embedded on or more computer programs, said one or more computer programs implementing a method for determining a relative location in a two-dimensional space of words mutually related in an arbitrary field, said one or more computer programs comprising a set of instructions for:
(a) receiving n documents B(i) relating to the arbitrary field, m lexical neighborhood lexical items W(i) of lexical items used in the arbitrary field, k specified lexical items A(i), and location information P on the k specified lexical items A(i) in the two-dimensional space;
(b) determining an n by m frequency matrix V(i,j) using the n documents B(i) relating to the arbitrary field, and the m lexical neighborhood lexical items W(i);
(c) calculating an m by m observed distance matrix M(i,j) using the n by m frequency matrix V(i,j);
(d) determining an m by m lexical location matrix D(i,j) from the location information P in the two-dimensional space on the specified lexical items and initial locations determined arbitrarily in the two-dimensional space of lexical items other than the specified lexical items; and
(e) determining a stress function S based on the m by m lexical location matrix D(i,j) and the m by m observed distance matrix M(i,j), and determining an m by m lexical location matrix D(i,j) minimizing the stress function S.

6. A method of determining a relative location in a two-dimensional space of words mutually related in an arbitrary field by controlling a computer to perform the steps of:
(a) receiving n documents B(i) relating to the arbitrary field, m lexical neighborhood lexical items W(i) of lexical items used in the arbitrary field, k specified lexical items A(i), and location information P on the k specified lexical items A(i) in the two-dimensional space;
(b) determining an n by m frequency matrix V(i,j) using the n documents B(i) relating to the arbitrary field, and the m lexical neighborhood lexical items W(i);
(c) calculating an m by m observed distance matrix M(i,j) using the n by m frequency matrix V(i,j);
(d) determining an m by m lexical location matrix D(i,j) from the location information P in the two-dimensional space on the specified lexical items and initial locations determined arbitrarily in the two-dimensional space of lexical items other than the specified lexical items; and
(e) determining a stress function S based on the m by m lexical location matrix D(i,j) and the m by m observed distance matrix M(i,j), and determining an m by m lexical location matrix D(i,j) minimizing the stress function S.

7. A method according to claim 6, wherein the step of calculating the m by m observed distance matrix M(i,j) further comprises the steps of:
(a) determining an m by m co-occurrence matrix C(i,j) according to (Equation 1):
C(i,j)=V^{T}V (Equation 1)
where T denotes a trans location of a matrix; and
(b) determining the m by m observed distance matrix M(i,j) from the m by m co-occurrence matrix C(i,j) according to (Equation 2):
M(i,j)=−2×C(i,j)/{tf(i)×tf(j)} for C(i,j)≠0
{tf(i)×tf(j)}/(2×β) for C(i,j)=0 (Equation 2)
where C(i,j) is a value of the co-occurrence matrix of each vocabulary pair, tf(j) is a frequency of a vocabulary in entire documents, and β is a maximum value of tf(i) (i=1 to m).

8. A method according to claim 6, wherein the step of receiving the specified lexical items, and the locations of the specified lexical items in the two-dimensional space receives at least three specified lexical items, and locations of the specified lexical items in the two-dimensional space.

9. A method according to claim 6, further comprising the steps of:
(a) receiving a specification of a naïve vocabulary;
(b) selecting row data corresponding to the naïve vocabulary from a lexical mapping matrix;
(c) selecting an expert vocabulary corresponding to the selected row data, and a column data corresponding to the expert vocabulary; and
(d) determining a naïve vocabulary corresponding the selected column data, and determining the lexical neighborhood vocabulary W(i).
